(19) United States
(12) Patent Application Publication
(10) Pub. No.: US 2012/0301244 A1
(43) Pub. Date: Nov. 29, 2012

(54) FLOATING FASTENER

(76) Inventor: Ming-Chung CHIU, Keelung Cilty (TW)

(21) Appl. No.: 13/198,059

(22) Filed: Aug. 4, 2011

(30) Foreign Application Priority Data
May 24, 2011 (TW) 100118141

(51) Int. Cl. F16B 39/02

(52) U.S. Cl. 411/166

(57) ABSTRACT

A floating fastener includes a connection member fastened to a first plate member with a lock screw member, a retaining member installed in a second plate member, a rotary locking device coupled to the connection member and having a locking shank and a shank head with longitudinal cut planes and insertable through the retaining member, a spring member supported between the top wall of the connection member and a step around the periphery of the locking shank, a knob affixed to the top end of the locking shank and operable to bias the locking shank between a locking position where the shank head is forced into engagement with the retaining member and an unlocking position where the shank head is disengaged from the retaining member, and an elastic cushion ring supported between the connection member and the knob.

This application claims the priority benefit of Taiwan patent application number 100118141, filed on May 24, 2011.

### BACKGROUND OF THE INVENTION

1. Field of the Invention

The present invention relates to fasteners for joining metal plate members and more particularly, to a floating fastener, which assures locking stability, avoiding accidental disengagement between parts and accidental separation of the first plate member from the second plate member.

2. Description of the Related Art

Screws or pins are commonly used many different products for the positioning of movable members. For example, a lock pin may be used to lock a sliding box or board member when the sliding rails of the sliding box or board member are moved relative to respective sliding grooves to a predetermined position, facilitating user's operation. In a desk computer system, industrial computer system, work station or any other equipment where movable plate members are detachably arranged together, screws or pins may also be used to lock the movable plate members together, facilitating mounting and dismounting. To facilitate detachable installation and to avoid missing component parts, floating fasteners are created.

FIGS. 9 and 10 illustrate a floating fastener according to the prior art. According to this design, the floating fastener comprises a connection member A, a locking device B consisting of a knob B1 and a locking shank B2, a spring member C and a lock screw D. The lock screw D is inserted through a mounting through hole E1 of a first plate member E and fastened to the connection member A to affix the connection member A to the first plate member E. The locking shank B2 has a shank body B21 upwardly inserted through a top center hole All of the connection member A, and a relatively thicker shank head B22 located on the bottom end of the shank body B21 for fastening to a retaining hole F1 of a second plate member F to lock the first plate member E to the second plate member F. The spring member C is sleeved onto the shank body B21 of the locking shank B2 and stopped between the relatively thicker shank head B22 and the top wall of the connection member A. When locking the first plate member E to the second plate member F, the relatively thicker shank head B22 is directly and axially forced into engagement with the retaining hole F1 of the second plate member F. When unlocking the first plate member E from the second plate member F, the relatively thicker shank head B22 is directly upped upwardly away from the retaining hole F1 of the second plate member F. This design of floating fastener is still not satisfactory in function. When the second plate member F is pulled by an external force, a shearing force may be produced, causing disconnection of the relatively thicker shank head B22 from the retaining hole F1 of the second plate member F. During a wiring work, or transfer or delivery of the equipment, the relatively thicker shank head B22 may be forced away from the retaining hole F1 of the second plate member F accidentally, leading to component or equipment damage.

Therefore, it is desirable to provide a floating fastener that eliminates the aforesaid problem.

### SUMMARY OF THE INVENTION

The present invention has been accomplished under the circumstances in view. It is therefore an object of the present invention to provide a floating fastener for detachably fastening a first plate member to a second plate member, which assures locking stability, avoiding accidental disengagement between parts and accidental separation of the first plate member from the second plate member.

To achieve this and other objects of the present invention, a floating fastener comprises a connection member fastened to a first plate member with a lock screw member, a retaining member having a center retaining hole with low inside wall portions, high inside wall portions, positioning grooves and locating grooves and installed in a second plate member, a rotary locking device coupled to the connection member and having a locking shank and a shank head with longitudinal cut planes and a bottom stop flange and insertable through the retaining member, a spring member supported between the top wall of the connection member and a step around the periphery of the locking shank, a knob affixed to the top end of the locking shank and operable to bias the locking shank between a locking position and an unlocking position.

The shank head of the locking shank is forced into the center retaining hole of the retaining member at the second plate member when the longitudinal cut planes and bottom stop flange of the locking shank are respectively kept in alignment with the low inside wall portions and high inside wall portions of the retaining member. After insertion of the shank head of the locking shank into the center retaining hole of the retaining member, press the knob downwards and rotate the rotary locking device to force the arched faces and bottom stop flange of the locking shank into engagement with the respective positioning grooves and locating grooves, and therefore the second plate member is locked to the first plate member firmly, avoiding accidental disconnection.

### BRIEF DESCRIPTION OF THE DRAWINGS

FIG. 1 is an oblique top elevation of a floating fastener in accordance with a first embodiment of the present invention.

FIG. 2 is an exploded view of the floating fastener in accordance with the first embodiment of the present invention.

FIG. 3 corresponds to FIG. 2 when viewed from another angle.

FIG. 4 is a sectional side view of the floating fastener in accordance with the first embodiment of the present invention.

FIG. 5 is a schematic sectional applied view of the first embodiment of the present invention, illustrating the floating fastener fastened to the first metal plate member before installation of the retaining member in the second plate member.

FIG. 6 corresponds to FIG. 5, illustrating the retaining member installed in the second plate member.

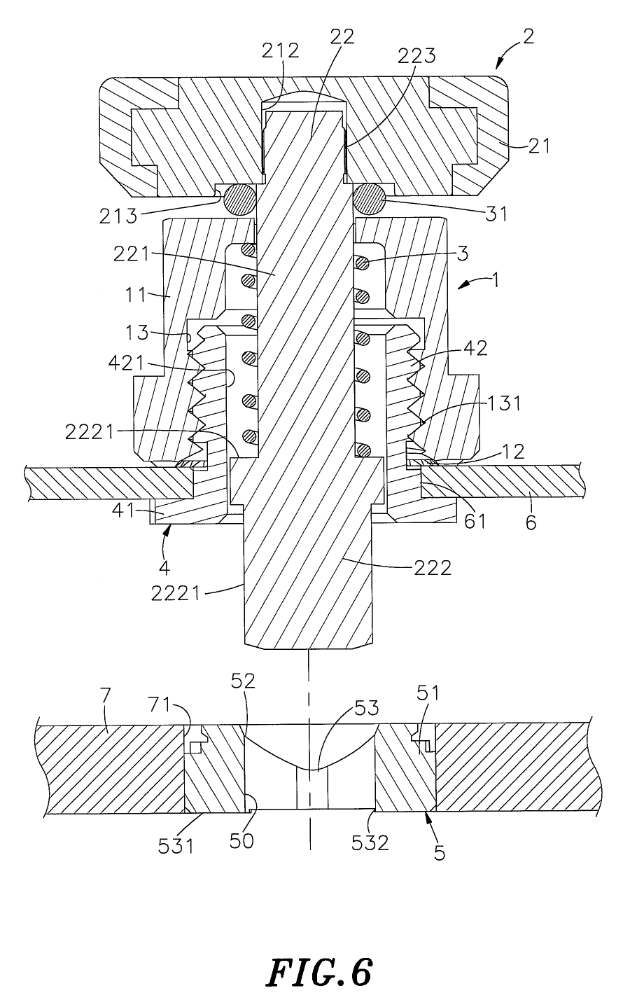

FIG. 7 corresponds to FIG. 6, illustrating the rotary locking device fastened to the retaining member at the second plate member.

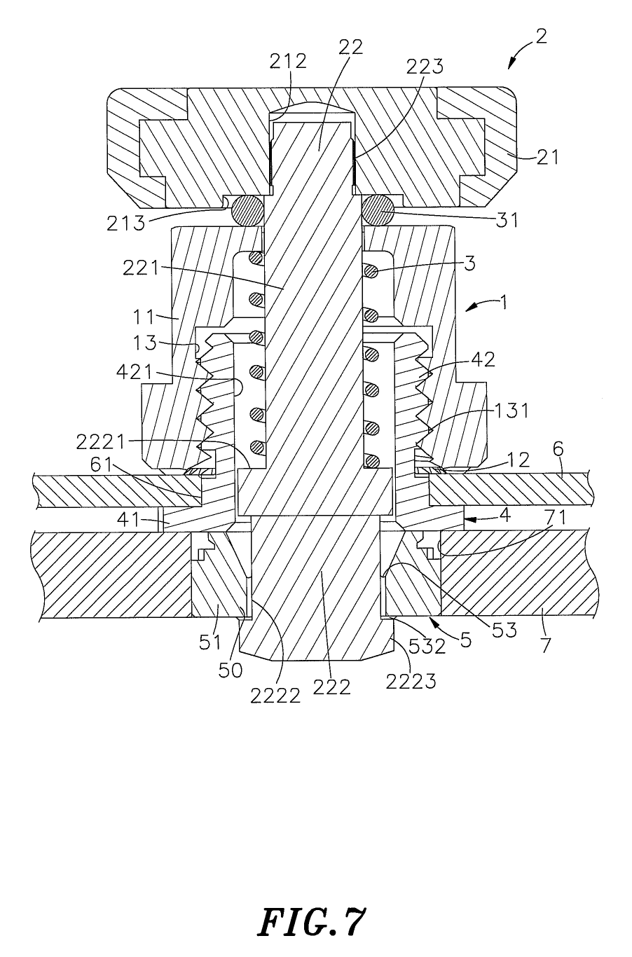

FIG. 8 is a sectional view of a floating fastener in accordance with a second embodiment of the present invention.

FIG. 9 is an exploded view of a floating fastener according to the prior art.

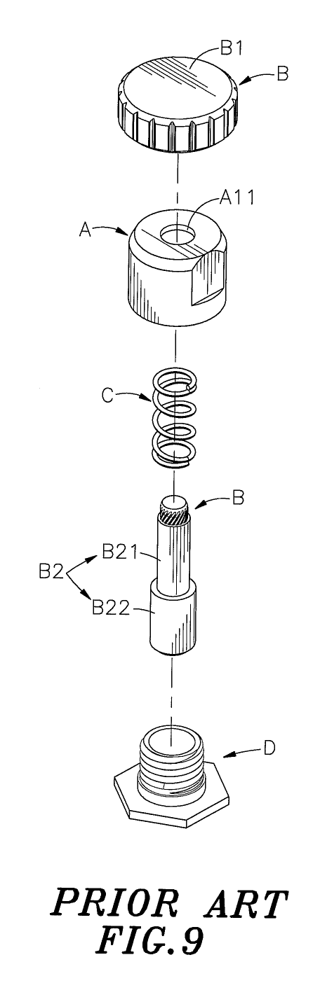

FIG. 10 is a sectional view of the floating fastener according to the prior art.

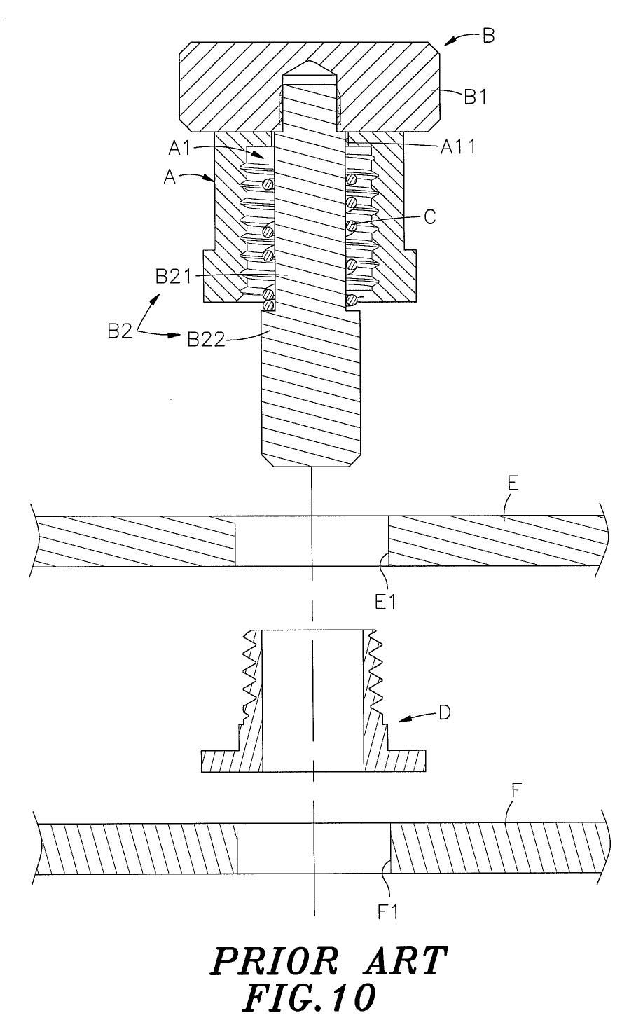

### DETAILED DESCRIPTION OF THE PREFERRED EMBODIMENT

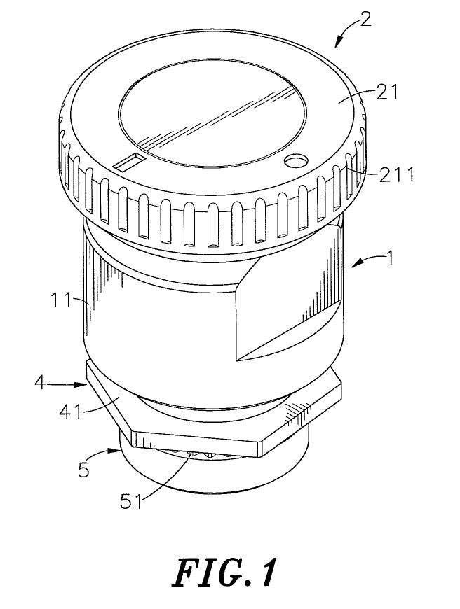

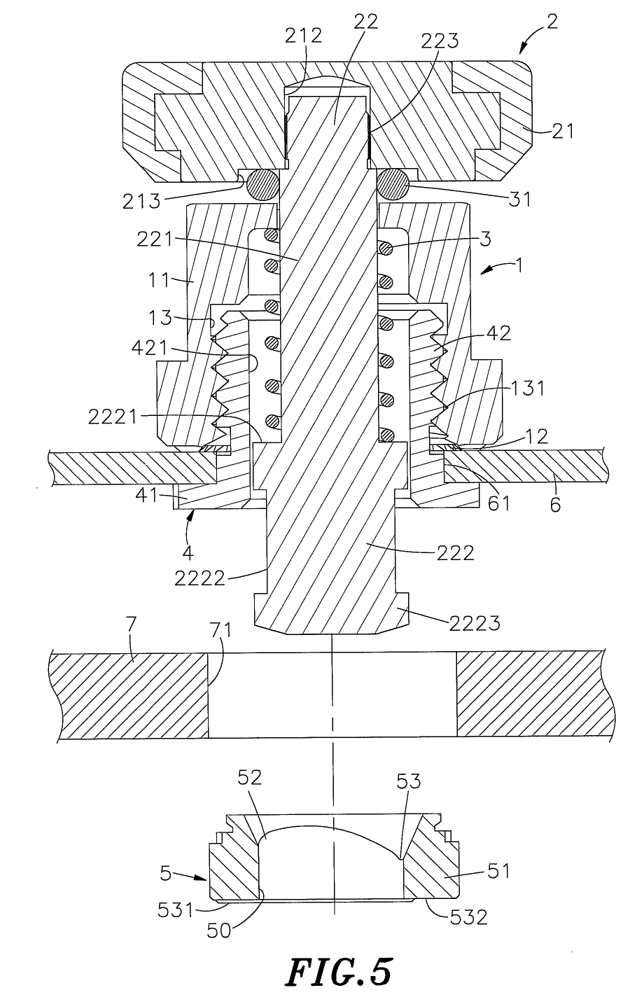

Referring to FIGS. 1-5, a floating fastener in accordance with a first embodiment of the present invention is shown comprising a connection member 1, a rotary locking device 2, a spring member 3, an elastic cushion ring 31, a lock screw member 4 and a retaining member 5.

The connection member 1 comprises a tubular body 11 having a bottom open chamber 13, an embossed positioning portion 12 located on the bottom edge thereof around the bottom open side of the bottom open chamber 13, a top center hole 132 located on the top side thereof in communication with the bottom open chamber 13, and an inner thread 131 spirally extending around an inside wall thereof in the bottom open chamber 13.

The rotary locking device 2 comprises a knob 21 disposed above the connection member 1, and a locking shank 22 connected to the knob 21 and inserted through the top center hole 132 and the bottom open chamber 13 of the connection member 1. The knob 21 has a plurality of vertical tooth grooves 211 spaced around the periphery thereof, a bottom recess 213 located on the center of the bottom wall thereof and a bottom mounting hole 212 located on the center of the bottom recess 213. The locking shank 22 has a plain shank body 221, a top mounting portion 223 located on one end of the plain shank body 221 and riveted to the bottom mounting hole 212 of the knob 21, a shank head 222 located on the other end of the plain shank body 221 and a step 2211 connected between the plain shank body 221 and the shank head 222. The shank head 222 has a diameter greater than the plain shank body 221, two longitudinal cut planes 2221 and two arched faces 2222 alternately spaced around the periphery and abutted against one another, and a bottom stop flange 2223 extending around the bottom end thereof beyond the longitudinal cut planes 2221 remote from the plain shank body 221.

The spring member 3 is sleeved onto the locking shank 22 of the rotary locking device 2, having its one end stopped against an inside part of the tubular body 11 of the connection member 1 around the top center hole 132 and its other end stopped against the step 2211 of the rotary locking device 2.

The elastic cushion ring 31 is elastically compressibly set in between the bottom recess 213 of the knob 21 and the top wall of the connection member 1 around the top center hole 132.

The lock screw member 4 comprises a screw tube 42 threaded into the inner thread 131 of the connection member 1, a screw head 41 radially outwardly extending around the periphery of the bottom end of the screw tube 42 and an axial hole 421 surrounded by the screw tube 42.

The retaining member 5 comprises a center retaining hole 50 cut through top and bottom sides thereof, an embossed engagement portion 51 located on the top side around the center retaining hole 50 for positioning in a mounting through hole 71 of a second late member 7, two high inside wall portions 52 and two low inside wall portions 53 alternatively arranged around the center retaining hole 50 and connected to one another in a flush manner corresponding to the longitudinal cut planes 2221 and two arched faces 2222 of the locking shank 22 of the rotary locking device 2, two positioning grooves 531 respectively located on the low inside wall portions 53 and two locating grooves 532 located on the bottom side of the retaining member 5 corresponding to the positioning grooves 531.

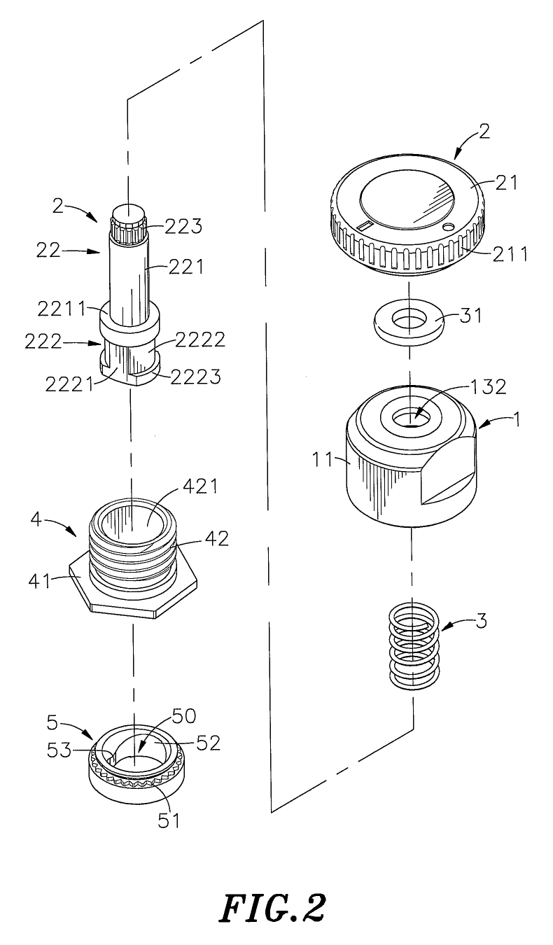

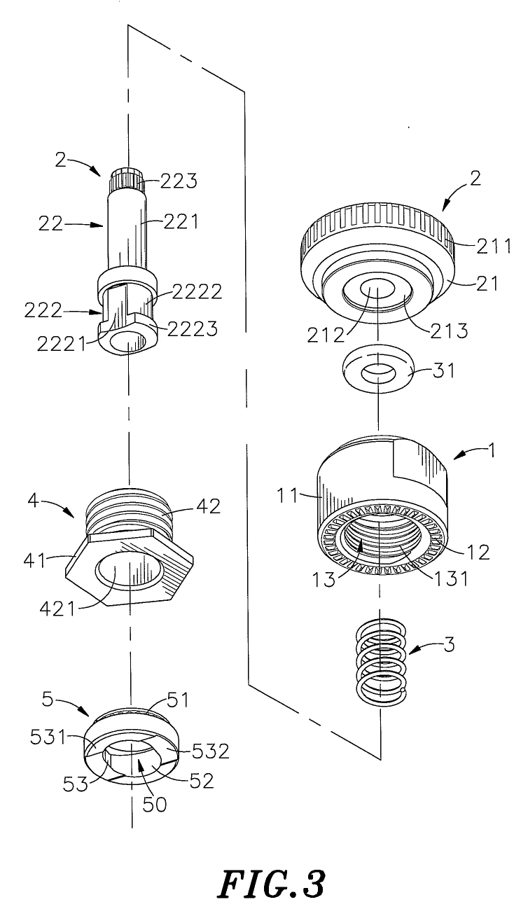

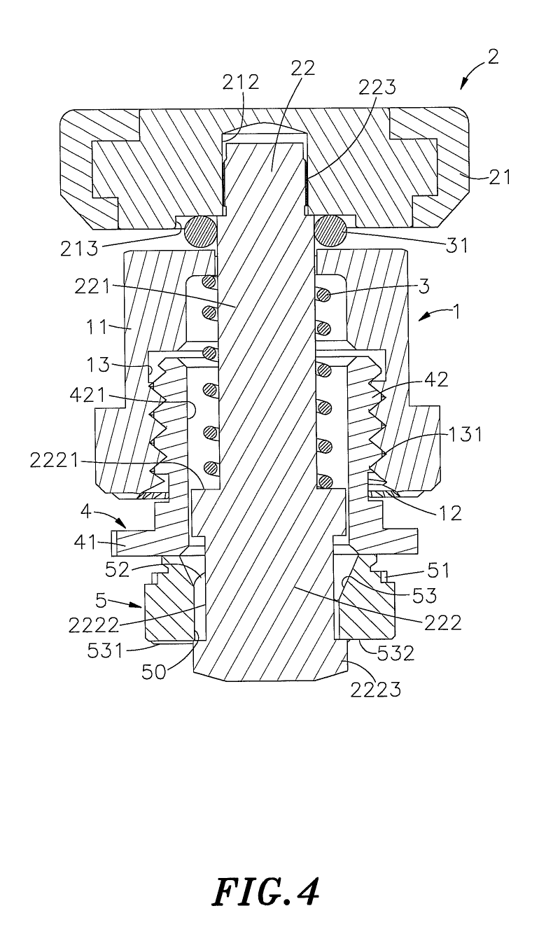

Referring to FIGS. 4˜7 and FIGS. 2 and 3 again, during installation of the floating fastener, insert the top mounting portion 223 of the locking shank 22 upwardly in proper order through the spring member 3, the bottom open chamber 13 and top center hole 132 of the connection member 1 and the elastic cushion ring 31, and the riveting the top mounting portion 223 to the bottom mounting hole 212 of the knob 21. At this time, the spring member 3 is received in the bottom open chamber 13 of the connection member 1 and stopped the inner surface of the top wall of the tubular body 11 of the connection member 1 around the top center hole 132 and the step 2211 of the rotary locking device 2, and the elastic cushion ring 31 is accommodated in the bottom recess 213 of the knob 21. Thereafter, attach the embossed positioning portion 12 of the connection member 1 to the top wall of a first plate member 6 around a mounting through hole 61, and then insert the screw tube 42 of the lock screw member 4 upwardly through the mounting through hole 61 of the first plate member 6 and thread the screw tube 42 into the inner thread 131 of the connection member 1 to lock the connection member 1 to the first plate member 6. When attaching the second plate member 7 to the first plate member 6 to keep the center retaining hole 50 of the retaining member 5 that is affixed to the mounting through hole 71 of the second plate member 7 in alignment with the mounting through hole 61 of the first plate member 6, the spring member 3 imparts an outward pressure to the step 2211 to force the shank head 222 of the locking shank 22 into the center retaining hole 50 of the retaining member 5 at the second plate member 7. At this time, the longitudinal cut planes 2221 and bottom stop flange 2223 of the locking shank 22 are respectively aimed at the low inside wall portions 53 and the high inside wall portions 52 of the retaining member 5 for allowing the shank head 222 to enter the center retaining hole 50. Thereafter, press the knob 21 to compress the elastic cushion ring 31 against the connection member 1 to force the shank head 222 to enter the center retaining hole 50. After the bottom stop flange 2223 passed downwardly over the bottom side of the second plate member 7, rotate the rotary locking device 2 through 90° angle to force the arched faces 2222 into the positioning grooves 531 respectively. After the user released the hand from the knob 21, the elastic cushion ring 31 immediately returns to its former shape, causing the bottom stop flange 2223 of the locking shank 22 to be forced into engagement with the locating grooves 532, enhancing locking tightness and avoiding accidental disengagement of the shank head 222 of the locking shank 22 from the center retaining hole 50 of the retaining member 5 at the second plate member 7.

When going to detach the second plate member 7 from the first plate member 6, press the knob 21 to compress the elastic cushion ring 31 against the connection member 1 and to move the bottom stop flange 2223 of the locking shank 22 downwardly away from the locating grooves 532, and then rotate the rotary locking device 2 through 90° angle to move the arched faces 2222 away from the respective positioning grooves 531 and simultaneously to move the shank head 222 of the locking shank 22 into axial alignment with the longitudinal cut planes 2221 and the bottom stop flange 2223 into axial alignment with into axial alignment with the high inside wall portions 52, enabling the shank head 222 to be retracted into the center retaining hole 50. When released the pressure from the rotary locking device 2 at this time, the spring member 3 returns to its former shape, and therefore the second plate member 7 is unlocked from the first plate member 6 and can be moved away freely.

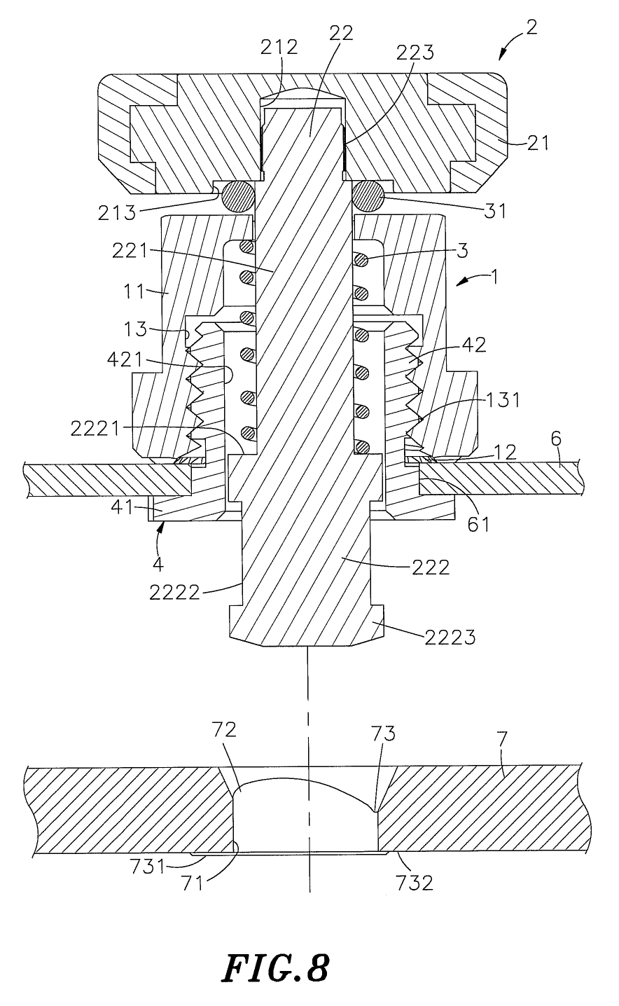

FIG. 8 illustrates an alternate form of the present invention. This second embodiment is substantially similar to the aforesaid first embodiment with the exception that the retaining member 5 is eliminated, and the mounting through hole 71 of the second plate member 7 is designed subject to the structure of the retaining member 5, i.e., the second plate member 7 comprises two high inside wall portions 72 and two low inside wall portions 73 alternatively arranged around the mounting through hole 71 and connected to one another in a flush manner corresponding to the longitudinal cut planes 2221 and two arched faces 2222 of the locking shank 22 of the rotary locking device 2, two positioning grooves 731 respectively located on the low inside wall portions 73 and two locating grooves 732 located on the bottom side of the second plate member 7 corresponding to the positioning grooves 531.

In general, the invention provides a floating fastener for detachably fastening the second plate member 7 to the first plate member 6. Subject to the spring force of the spring member 3, the shank head 222 of the locking shank 22 is forced into the center retaining hole 50 of the retaining member 5 at the second plate member 7 when the longitudinal cut planes 2221 and the bottom stop flange 2223 of the locking shank 22 are respectively kept in alignment with the high inside wall portions 52 and the low inside wall portions 53 of the retaining member 5. After insertion of the shank head 222 of the locking shank 22 into the center retaining hole 50 of the retaining member 5 at the second plate member 7, press the knob 21 downwards and rotate the rotary locking device 2 to force the arched faces 2222 and the bottom stop flange 2223 of the locking shank 22 into engagement with the positioning grooves 531 and the locating grooves 532 respectively, and therefore the second plate member 7 is locked to the first plate member 6 firmly. Further, the shank head 222 can be made having one single longitudinal cut plane 2221 or two longitudinal cut planes 2221, and the retaining member 5 can be made having one single low inside wall portion 53 or two inside wall portions 53, achieving the same effects.

Although particular embodiments of the invention have been described in detail for purposes of illustration, various modifications and enhancements may be made without departing from the spirit and scope of the invention.

What the invention claimed is:

1. A floating fastener mounted in a mounting through hole of a first metal plate member for detachably fastening said first metal plate member to a mounting through hole of a second metal plate member, the floating fastener comprising:
a connection member comprising a tubular body having a bottom open chamber, a top center hole located on a top side thereof in communication with said bottom open chamber, and an inner thread spirally extending around an inside wall thereof in said bottom open chamber;
a rotary locking device axially slidably coupled to said connection member, said rotary locking device comprising a knob disposed above said connection member and a locking shank connected to said knob and inserted through said top center hole and said bottom open chamber of said connection member, said locking shank comprising a plain shank body connected to said knob, a shank head axially extended from one end of said plain shank body remote from said knob, said shank head having a diameter greater than said plain shank body, a step connected between said plain shank body and said shank head, at least one longitudinal cut plane and at least one arched face alternately spaced around the periphery of said shank head and abutted against one another in a flush manner, and a bottom stop flange extending around a bottom end of said shank head remote from said plain shank body and beyond said at least one longitudinal cut plane;
a spring member sleeved onto said locking shank of said rotary locking device and stopped an inside part of said tubular body of said connection member around said top center hole and said step of said rotary locking device;
an elastic cushion ring elastically compressibly set in between said knob and said connection member;
a lock screw member adapted for fastening said connection member to the mounting through hole of said first plate member, said lock screw member comprising a screw tube threaded into said inner thread of said connection member, a screw head radially outwardly extending around the periphery of a bottom end of said screw tube and an axial hole surrounded by said screw tube for the passing of said locking shank; and
a retaining member installed in the mounting through hole of said second plate member for engagement with said shank head of said locking shank of said rotary locking device, said retaining member comprising a center retaining hole cut through top and bottom sides thereof, at least one high inside wall portion and at least one low inside wall portion alternatively arranged around said center retaining hole and connected to one another in a flush manner corresponding to said at least one longitudinal cut plane and said at least one arched face of said locking shank of said rotary locking device; and
wherein said shank head of said locking shank is axially insertable in and out of said center retaining hole of said retaining member when said at least one longitudinal cut plane and said bottom stop flange of said locking shank are respectively kept in axial alignment with the at least one low inside wall portion and at least one high inside wall portion of said retaining member; said shank head of said locking shank is locked to said retaining member after insertion of said shank head through said center retaining hole of said retaining member and rotated relative to said retaining member through a predetermined angle.

2. The floating fastener as claimed in claim 1, wherein said connection member comprises an embossed positioning portion located on a bottom edge of the tubular body thereof around a bottom open side of said bottom open chamber for positioning on a top wall of said first plate member.

3. The floating fastener as claimed in claim 1, wherein said knob of said rotary locking device comprises a bottom mounting hole located on the center of a bottom wall thereof; said locking shank of said rotary locking device comprises a top mounting portion located on one end of said plain shank body opposite to said shank head and riveted to the bottom mounting hole of said knob.

4. The floating fastener as claimed in claim 1, wherein said knob of said rotary locking device comprises a plurality of vertical tooth grooves spaced around the periphery thereof.

5. The floating fastener as claimed in claim 1, wherein said knob of said rotary locking device comprises a bottom recess located on the center of a bottom wall thereof for accommodating said elastic cushion ring, and a bottom mounting hole located on the center of said bottom recess; said locking shank of said rotary locking device comprises a top mounting portion located on one end of said plain shank body opposite to said shank head and riveted to the bottom mounting hole of said knob.

6. The floating fastener as claimed in claim 1, wherein said locking shank comprises two longitudinal cut planes and two arched faces alternately spaced around the periphery of said shank head and abutted against one another in a flush manner.

7. The floating fastener as claimed in claim 6, wherein aid retaining member comprises at least one positioning groove respectively located on said at least one low inside wall portion for the engagement of said at least one arched face.

8. The floating fastener as claimed in claim 1, wherein said elastic cushion ring is set in between a bottom recess on a bottom wall of said knob and a top wall of said tubular body of said connection member around said top center hole.

9. The floating fastener as claimed in claim 1, wherein said retaining member comprises an embossed engagement portion located on a top side thereof around said center retaining hole for positioning in the mounting through hole of said second plate member.

10. The floating fastener as claimed in claim 6, wherein said retaining member comprises at least one locating groove located on a bottom side thereof for engagement with the bottom stop flange of said locking shank of said rotary locking device.

11. A floating fastener mounted in a mounting through hole of a first plate member for detachably fastening said first plate member to a mounting through hole of a second plate member, the floating fastener comprising:
a connection member comprising a tubular body having a bottom open chamber, a top center hole located on a top side thereof in communication with said bottom open chamber, and an inner thread spirally extending around an inside wall thereof in said bottom open chamber;
a rotary locking device axially slidably coupled to said connection member, said rotary locking device comprising a knob disposed above said connection member and a locking shank connected to said knob and inserted through said top center hole and said bottom open chamber of said connection member, said locking shank comprising a plain shank body connected to said knob, a shank head axially extended from one end of said plain shank body remote from said knob, said shank head having a diameter greater than said plain shank body, a step connected between said plain shank body and said shank head, at least one longitudinal cut plane and at least one arched face alternately spaced around the periphery of said shank head and abutted against one another in a flush manner, and a bottom stop flange extending around a bottom end of said shank head remote from said plain shank body and beyond said at least one longitudinal cut plane;
a spring member sleeved onto said locking shank of said rotary locking device and stopped an inside part of said tubular body of said connection member around said top center hole and said step of said rotary locking device;
an elastic cushion ring elastically compressibly set in between said knob and said connection member;
a lock screw member adapted for fastening said connection member to the mounting through hole of said first plate member, said lock screw member comprising a screw tube threaded into said inner thread of said connection member, a screw head radially outwardly extending around the periphery of a bottom end of said screw tube and an axial hole surrounded by said screw tube for the passing of said locking shank; and
a second plate member for engagement with said shank head of said locking shank of said rotary locking device, said second plate member comprising a retaining hole cut through top and bottom sides thereof, at least one high inside wall portion and at least one low inside wall portion alternatively arranged around said retaining hole and connected to one another in a flush manner corresponding to said at least one longitudinal cut plane and said at least one arched face of said locking shank of said rotary locking device; and
wherein said shank head of said locking shank is axially insertable in and out of said retaining hole of said second plate member when said at least one longitudinal cut plane and said bottom stop flange of said locking shank are respectively kept in axial alignment with the at least one low inside wall portion and at least one high inside wall portion of said second plate member; said shank head of said locking shank is locked to said second plate member after insertion of said shank head through said retaining hole of said second plate member and rotated relative to said second plate member through a predetermined angle.

12. The floating fastener as claimed in claim 11, wherein said connection member comprises an embossed positioning portion located on a bottom edge of the tubular body thereof around a bottom open side of said bottom open chamber for positioning on a top wall of said first plate member.

13. The floating fastener as claimed in claim 11, wherein said knob of said rotary locking device comprises a bottom mounting hole located on the center of a bottom wall thereof; said locking shank of said rotary locking device comprises a top mounting portion located on one end of said plain shank body opposite to said shank head and riveted to the bottom mounting hole of said knob.

14. The floating fastener as claimed in claim 11, wherein said knob of said rotary locking device comprises a plurality of vertical tooth grooves spaced around the periphery thereof.

15. The floating fastener as claimed in claim 11, wherein said knob of said rotary locking device comprises a bottom recess located on the center of a bottom wall thereof for accommodating said elastic cushion ring, and a bottom mounting hole located on the center of said bottom recess; said locking shank of said rotary locking device comprises a top mounting portion located on one end of said plain shank body opposite to said shank head and riveted to the bottom mounting hole of said knob.

16. The floating fastener as claimed in claim 11, wherein said locking shank comprises two longitudinal cut planes and two arched faces alternately spaced around the periphery of said shank head and abutted against one another in a flush manner.

17. The floating fastener as claimed in claim 16, wherein said retaining member comprises at least one positioning groove respectively located on said at least one low inside wall portion for the engagement of said at least one arched face.

18. The floating fastener as claimed in claim 11, wherein said elastic cushion ring is set in between a bottom recess on a bottom wall of said knob and a top wall of said tubular body of said connection member around said top center hole.

19. The floating fastener as claimed in claim 16, wherein said second plate member comprises at least one locating groove located on a bottom side thereof for engagement with the bottom stop flange of said locking shank of said rotary locking device.
